(19) United States
(12) Patent Application Publication
(10) Pub. No.: US 2015/0223409 A1
(43) Pub. Date: Aug. 13, 2015

(54) DESALINATION GREENHOUSE

(71) Applicant: MANSUR ABAHUSAYN, Mission Viejo, CA (US)

(72) Inventor: MANSUR ABAHUSAYN, Mission Viejo, CA (US)

(21) Appl. No.: 14/696,484

(22) Filed: Apr. 27, 2015

Related U.S. Application Data
(63) Continuation-in-part of application No. 13/359,493, filed on Jan. 26, 2012.

(51) Int. Cl. A01G 9/14; A01G 9/24

(52) U.S. Cl. CPC A01G 9/14; A01G 9/246; A01G 2009/248

(57) ABSTRACT

A desalination greenhouse includes a method of fresh water production hybridized with growth and production of a crop. The co-location of a growing crop can provide additional economic incentive to a hybrid system, and provide a moisture enhancement to an internal atmosphere which can be utilized to more efficiently produce and yet benefit from the production of water without the salt content, and as well to concentrate the salt content of brine which is used in another salt production operation. A further substantial achievement could be obtained by desalinization of water by using renewable energy economically and saving 95% of water normally used in open field irrigation of crops.

This application is a continuation-in-part application of co-pending U.S. patent application Ser. No. 13/359,493 filed Jan. 26, 2012.

### FIELD OF THE INVENTION

The present invention relates to improvements in economic desalination of water by the use of a renewable energy, water efficient greenhouse structure that additionally provides for efficient growth of an agricultural crop with the greenhouse system enabled to use seawater or brackish water to produce fresh water and to produce a concentrated brine suitable for further processing to solid form. A lowered humidity stream can be used for an evaporative cooling process and can achieve lower, more efficient cooled temperatures for more efficient production of a crop with the presence of the growing crop in turn facilitating efficient humidity maintenance within the greenhouse; the result being more efficient water production, the ability to grow crops in a shorter time period while using only a small fraction of the water which would otherwise be utilized in open field production. Both of the two greenhouse and system embodiments are amenable to automated and continuous agricultural production.

2. Background of the Invention

In arid areas of the world a conventional greenhouse has a number of disadvantages. Increased sun light can cause a greenhouse to overheat. The answer to overheating has been to open the greenhouse to a cross breeze and increase evaporation for cooling. However, in desert areas this simply translates into a prohibitively greater water usage than would be experienced with the greenhouse in cooler climates. A conventional greenhouse project in the desert would normally require a commitment of several multiples of the amount of water than would be necessary in a cooler climate. Conventional greenhouses contemplate fresh water to be applied to plants in an amount to not only provide a nourishment medium for the plants, but also to humidify the internal space within the greenhouse. However, the internal space within the greenhouse must not over heat, and the main mechanism to prevent overheating is to create a cross draft of outside air to cool. However, this cooling evaporates and dehumidifies the interior growing space of the greenhouse.

The desert environment is well known to have very little fresh water available, or perhaps only sea water, brine from groundwater desalination plants or brackish water available. Such desert environment is also known to have high solar availability, but suffers from excess temperatures associated with the intense solar exposure. The shortcomings of the conventional or more advanced solar still design, where water in an enclosure with a sun facing inclined transparent cover condenses desalinated water on the inside of the cover for collection. Its heat input may be increased by mirrors in order to increase yield of desalinated water per square meter of cover per day, however the original simple solar still and its many variations suffer from the following shortcomings: (1) when the solar still is dedicated for desalination only the cost of the structure becomes very expensive and so does the desalination process and output; (2) as the moisture in the tightly closed cavity of the still increases upon solar heating the evaporation is reduced and the still becomes less efficient; (3) Some of the desalinated water that condenses on the lower side of the transparent cover is preferentially evaporated relative to the salty water in the basin because of its lower density and therefore less salty water is evaporated; (4) there is a problem of obtaining an efficient condenser for the solar still and reliance on the air temperature outside the still to condense the water is not efficient, and the transparent cover becomes hot itself and the temperature drop between the evaporating moisture and the cover is not significant enough to allow substantial condensation; and (5) the above factors result in a still that is expensive with a low output of 2-5 liters per square meter per day. It is therefore desirable to invent a solar desalination device that is less expensive and is more productive per unit of space per day.

In 2015, the water shortage has become even more of a major international concern. The California governor recently signed a law mandating reduction of 25% of water use across the board as California, despite a widely varying area, faces what may be the most severe drought in its history. The urgency to desalinate sea/brackish and waste waters for potable, grow crops for food, for industrial and other uses cannot be more emphasized. Current methods for producing fresh water are energy intensive and do not integrate with other methods and structures. Such lack of integration, even where individual efficiencies are high, will not achieve the further advantages that integration has to offer.

### SUMMARY OF THE INVENTION

The desalination greenhouse is a solar distillation device that doubles as an insulated greenhouse. The desalinated water produced is very high quality and could be used for any purpose especially high value boiler and industry demineralized water as well as for potable, agriculture and any combination of the above as it is inexpensively produced. The structure is an insulated greenhouse where heat producing infra-red radiation is captured in forced air conduits, passes through evaporation pads to be humidified to saturation, then over a crop and through heat exchangers carrying cold water from the evaporation cooler to cause its condensation of the moisture laden air that passed over the crop. It uses inexpensive materials and renewable energy for power. The capital cost is therefore appropriated primarily for the greenhouse crop product, and the capital cost of desalination is significantly reduced. The desalination greenhouse of the invention also provides a number of flexible operation controls to produce crops rapidly in a desert environment using brackish water. Both winter and summer operations can be optimized and the desalination greenhouse helps to compensate for changing exterior process operating conditions. Even more surprisingly the desalination greenhouse can produce a source of potable water given an input of only brackish or sea water even when the ambient air is very humid.

The desalination greenhouse can be optimized for superior crop production and minimization of diseases. It minimizes heating and cooling requirements due to its superior insulation and absorption of heat in summer and its release in winter without obstructing natural light transmission. It uses renewable energy to desalinate water through condensation of sun and wind heated air that is forced through the cavity between the two structures to evaporate a very thin layer of water, and then to a black cover heated zone, to evaporative cooler wet pads. Condensation occurs on the inner surfaces of the outer and inner sections of the desalination greenhouse. Condensation of the inner greenhouse humid air may be achieved through a heat exchanger carrying the cooled water piped from the through of the evaporative cooling pads. The roof of the inner section of the desalination greenhouse is wetted evenly with sea or brackish water for evaporation which also cools the structure of the inner section of the desalination greenhouse. 1.0 to 10.0 mm v to u shaped grooves in the hard cover roof material of the inner section of the desalination greenhouse, preferably made of polycarbonate, guide the water downward and spread it evenly over the surface, providing the right depth for effective evaporation and cooling of the inner greenhouse. The inner greenhouse frame structure elements may be extended to support the outer greenhouse poly cover. The double shell greenhouse as described provides an efficient and cost effective means of heat utilization to desalinate sea or brackish water for irrigation and other uses, reduce heat input into the inner greenhouse, and minimize the crop requirement by over 95% by cutting the production cycle substantially and recovering the evapo-transpiration water.

The space over the water being desalinated is never saturated due to continuous air movement. The thickness of the salty water being evaporated is maintained at a very thin flow, within one centimeter, in order to chill the water to lower temperatures through evaporation and removal of moisture by the air. The even distribution of the salt water and its thin layer covering the roof and sides of the production greenhouse, made possible by the channel design (grooves) provides the production greenhouse with a cold surface that makes the environment more conducive to optimal plant growth and enhances condensation on the ceiling and sides of the production greenhouse. The outer shell greenhouse is a canopy to trap the moisture evaporating from the roof of the production greenhouse and enhances condensation on the ceiling and inside wall of the outer shell greenhouse.

A 1008 square meter floor greenhouse, for example, (36×28 and 4 meter high at the gutter and 8 meter high at the center) with one meter space between the inner and outer shell, has a total surface area of roof and sides of 2800 square meters allowing for doors and other vents. This area should produce about 10 liters per square meter per day, or 28,000 liters per day. A seawater desalination greenhouse of a single shell (1), which relied on cold deep seawater as a condenser, produced between 3 and 6 liters per square meter per day depending on whether the environment is tropical or oasis. When the crop produced in the present desalination greenhouse invention is barley for animal forage production, the cycle per crop averages ten days from seed to harvest (2). The desalination greenhouse will produce 1500 tons of forage annually and consumes 4500 cubic meters of desalinated water per year for irrigation.

The desalination greenhouse of the current invention produces over 10,000 cubic meters of desalinated water, enough for forage irrigation and drinking water for 1000 people, each using 15 liters per day. The desalination greenhouse of the current invention could contribute to solving problems of many regions of the world that require desalinated water for human consumption, industry and irrigation of crops. The high value of the desalinated water makes it valuable for boiler and chemical process water which is expensive to produce and requires substantial energy due to its high level of purity.

The air cycle steps of the desalination greenhouse may be represented as follows: Ambient air>disinfection>filter>blower>distribution>roof humidification>heating>pad humidification>condensation>ambient air. The water cycle steps in the desalination greenhouse may be represented and summarized as follows: a) Salty water. Salty water spread over roof of production greenhouse>evaporation and cooling on roof>evaporation and cooling on evaporation pads or water shower>heat exchanger condenser>Collection and recycle with bleed and blend with fresh salty water; b) Desalinated water. Condensed water on inside and walls of outer shell+Condensed water on inside and walls of production greenhouse+condensed water on heat exchanger carrying cold water from evaporation pads. All condensate is collected in their own gutter like channels separate from salty water channels.

Another method of fresh water production may be hybridized with growth and production of a crop. The co-location of a growing crop can provide additional economic incentive to a hybrid system, and provide a moisture enhancement to an internal atmosphere which can be utilized to more efficiently produce and yet benefit from the production of water without the salt content, and as well to concentrate the salt content of brine which is used in another salt production operation. A further substantial achievement could be obtained by desalinization of water by using renewable energy economically and saving 95% of water normally used in open field irrigation of crops. These goals are what the Solar Desalination Greenhouse , SDG, technology aims to achieve.

A Seawater Greenhouse was previously designed to desalinate sea water to irrigate crops. It had limited success due to the fact that it did not heat the air before the air passed through wet evaporation pads. Humid air common by the sea shore has a limited ability to evaporate more moisture. This limitation impacts the extent to which a temperature of the sea water wetting the condensation pads drops. The extent to which sea water is available to be used to wet the pads drops is extremely important as the cold water is used to condense the moisture of the greenhouse through heat exchangers. Desalination efficiency is correlated to the difference between the temperature of the sea water after the forced air passes through wet pads, the wet bulb temperature, and the temperature of the ambient air.

The Sea Water Greenhouse does not reduce the heat that enters the greenhouse and since the forced air wet bulb temperature has not dropped substantially, cooling is very limited. In arid regions the temperature inside the greenhouse in summer is very high, but to cool a greenhouse, a substantial drop in the wet bulb temperature needs to be achieved, as is the case with the solar desalination greenhouse of the invention. Unfortunately also, the sea water greenhouse had no means to dispose of the concentrated brine which is bled from the evaporation pads after it concentrates to a high level.

The solar desalination greenhouse of the invention overcomes these limitations with a design that captures the incident heat on the outer surface of the greenhouse structure and uses it to heat the forced air directed at the evaporation pads to reduce the heat buildup in the greenhouse structure and provide a more healthy environment for a growing crop withing the greenhouse structure. Near Infrared Radiation is preferably reflected by specially treated outer surface of the greenhouse cover and re-radiates the heat to the air forced in the conduits overlying the greenhouse roof. The desalination capacity of the solar desalination greenhouse is much higher than the sea water greenhouse because of the large difference in temperature between the wet bulb and dry bulb temperature. The solar desalination greenhouse will preferably dispose of a provided concentrated brine by further conversion of salt within its produced concentrated brine to crystalline solid salt. The solar desalination greenhouse preferably uses crops with a very short production cycle, normally about ten days, compared to three to five month production cycle for which the sea water greenhouse is designed. Such a short cycle increases production dramatically and contributes to greater economic feasibility.

The solar desalination greenhouse produces a greater amount of desalinated water per unit surface area. Water is continuously removed as water vapor from the wetted evaporation pads using sun heated forced air as a carrier. The solar desalination greenhouse reduces capital cost by synergizing to produce more than one product at the same time. The main obstacles of use of a conventional greenhouse in desert climates is overcome by reducing the heat entering the greenhouse and by using water that is not normally suited for agriculture.

Desalination of non-potable water to a potable level of quality occurs as a by-product of a bio-production automated system. The solar desalination green house desalinates by using renewable energy and employs principles of both mass and energy balance relating to humidification & dehumidification. The invention method captures incident heat on the greenhouse structure to use it for desalination efficiently. A few of the many benefits of the inventive structure and method are derived through use of the cooling process, use of inexpensive materials, and modular scalability. As a by-product, the desalinated water competes favorably with the least expensive conventional desalination technologies. The structure and method is environmentally friendly as it achieves zero-liquid discharge where the concentrated brine is be converted to crystalline salt using salt production techniques.

Incident heat on the surface of the greenhouse structure is used to heat streams of forced air carried in conduits covering the surface of the greenhouse structure. The production of potable water is achieved by humidification-dehumidification cycle, simulating the evaporation/condensation hydrological cycle, using the power of the sun, the thermodynamic properties of air and water, and the installation of a specially designed series of transparent conduits on top of or just below structure of the greenhouse. The heat incident on the structure is absorbed by the blower-forced air carried in the conduits. This reduces the incident heat that enters the inner greenhouse structure and provides a more favorable environment for the crop growing withing the greenhouse structure.

Further, the solar desalination greenhouse of the invention can profitably operate in some of the most harsh climates on earth. Data referenced for the operation of the Solar desalination greenhouse shown, are based on climate values for a site in Dhahran, Saudi Arabia where, for 249 days of the year, the average temperature is above 27° C. with an average relative humidity of 53 percent. Near Riyadh, the conditions are even more favorable for increased desalination as the air is drier and temperatures are higher. These localities are similar in aridity, and climate to the Imperial Valley of Southern California and the Yuma of Arizona supplied by water from the Colorado River and Lake Mead which is experiencing the severest water drought since it was constructed in the early 19^{th} century.

Heating of the air in a conduit increases its temperature and reduces it relative humidity. Only when air is below its vapor saturation point will it pick up moisture and cool itself and the pad evaporation water it passes over. Therefore the limitation that an evaporative cooling faces in humid climates such as near shorelines is averted. Solar desalination greenhouse makes it possible to desalinate water near the shoreline where sea water is used directly for irrigation of crops such as Salicornia and for desalination to produce potable water.

The greenhouse structure and the fluid conduits could be made from plastics, most commonly polycarbonates, polyethylene (PE), especially low density LDPE which is inexpensive and reasonably durable if coated with UV inhibitor. The greenhouse film is best treated with pigments or other compounds that reflect near infrared radiation (NIR) and thus reduce their entry to the interior of the greenhouse by directing them to the conduits and are beneficially used to heat the incoming forced air.

### BRIEF DESCRIPTION OF THE DRAWINGS

The invention, its configuration, construction, and operation will be best further described in the following detailed description, taken in conjunction with the accompanying drawings in which:

FIG. 1 is a perspective skeletal view of the desalination greenhouse of the present invention showing a nesting of the structures to create a separation space between an inner section and an outer section;

FIG. 2 is diagram of the structures within the desalination greenhouse which inlet air experiences during the expected operation;

FIG. 3 is a section taken along line 3-3 of FIG. 1 to illustrate the conversion of brackish water to potable water by condensation onto the inside surfaces of an outer section of the desalination greenhouse;

FIG. 4 is perspective of a panel having channels (grooves) in the plate surface which have a triangular cross-sectional shape to produce triangular channels, the plate used for roof and outer sides of the inner and outer shells of the desalination greenhouse;

FIG. 5 is cross sectional view of a plate which may or may not be the same overall size of the plate of FIG. 4, and illustrating a cross sectional profile having abbreviated height projections which define wide shallow channels;

FIG. 6 is cross sectional view of a plate which may or may not be the same overall size of the plate of FIG. 3, and illustrating a cross sectional profile having height projections which have a separation of about the same distance as their height;

FIG. 7 is a schematic of the components of a vortex system which is utilizable for cooling at one end and heating at the other in conjunction with the desalination greenhouse;

FIG. 8 is an expanded sectional view of the portion of the desalination greenhouse and illustrating separated vertical walls, and a fresh water reservoir feeding a system which includes heat exchange, storage, irrigation system storage and metered fertilizer;

FIG. 9 is a perspective skeletal view of a stackable production bin which may be preferably used on a conveyor;

FIG. 10 is a schematic water flow schematic for a further embodiment of a solar desalination greenhouse which operates without roof spraying and employs a growing crop both for economic crop production and to produce potable water, the water flow schematic shown without air flow for simplicity of explanation;

FIG. 11 is an air flow schematic for a further embodiment of a solar desalination greenhouse which employs a growing crop both for economic crop production and to produce potable water, the air flow schematic shown without water flow for simplicity of explanation;

FIG. 12 is a perspective partially broken-away view of the solar desalination greenhouse of the invention which employs a series of supported growing crop stacked structures on pallets to facilitate movement within and into and out of the greenhouse and includes a number of auxiliary structures; and

FIG. 13 is a perspective end view of the solar desalination greenhouse of the invention as was described in FIGS. 10-12.

### DETAILED DESCRIPTION OF THE PREFERRED EMBODIMENT

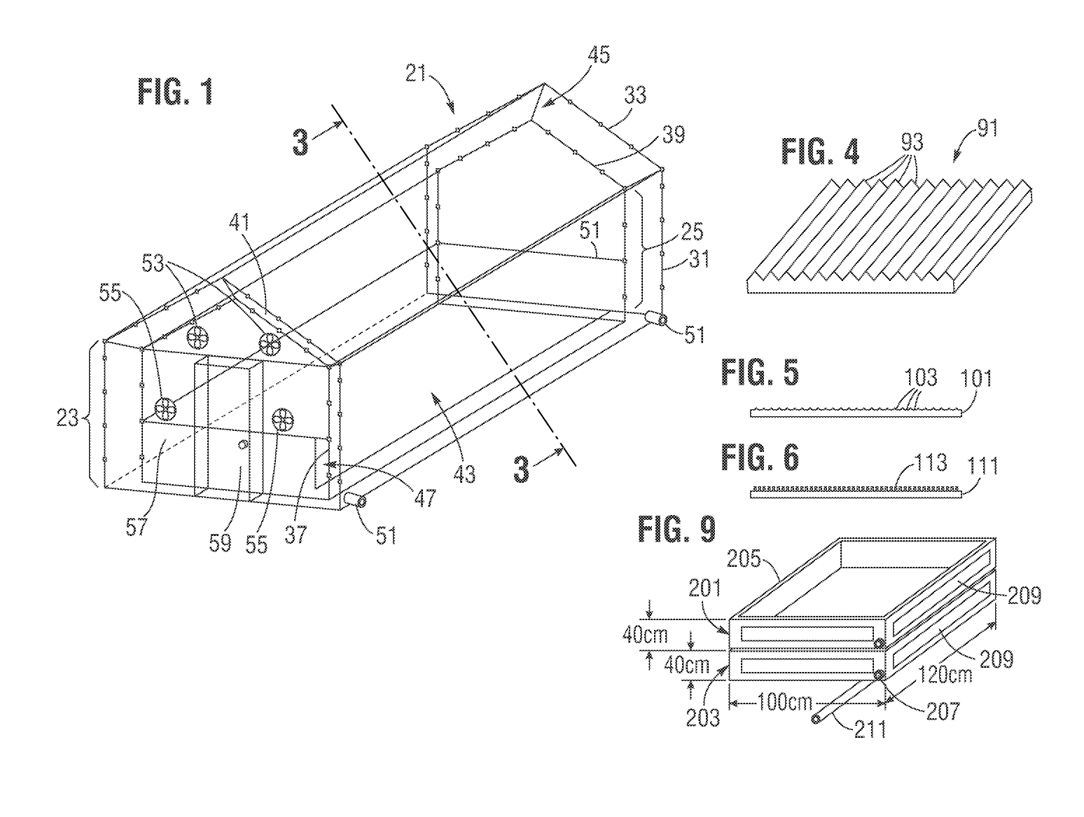

Referring to FIG. 1 a perspective skeletal view of one type of embodiment of a desalination greenhouse 21 which is shown as a long rectangular building, but need not be of the shape shown. The desalination greenhouse 21 is shown in a transparent view and includes an outer shell 23 for containment of water vapor, desalination, and light transmission; and an inner shell 25 which is in effect an inner greenhouse, and is for crop production, evaporative cooling and condensation of moisture.

The outer shell 23 shown is of simple construction and includes a series of vertical walls 31 which include side walls and end walls and topped by a roof 33 which includes a pair of sloped roof walls. Likewise, inner shell 25 shown is of simple construction and includes a series of vertical walls 37 which include side walls and end walls and topped by a roof 39 which includes a pair of sloped roof walls. Roofs 33, 39 of both greenhouses are preferably similar to each other (although shown in FIG. 1 as being parallel), they need not be. Both the roofs 33, 39 have roof walls shaped with a slant angle more than 15 and less than 60 degrees to facilitate condensate gravitationally sliding downward. Outer shell 23 has an inner chamber 41 while inner shell 25 has an inner chamber 43. Inner chamber 41 contains the inner shell 25 and is smaller, with the annular space between the outer shell and inner shell being referred to as a cavity and including a roof cavity 45 between the roofs 33 and 39 and a side cavity 47 between the vertical walls 31 and vertical walls 37.

Any number and type of protruding supports 51 may be anchored to the structural body of either of the outer shell 23 or inner shell 25 and for the purpose of anchoring the desalination greenhouse 21, securing the outer shell 23 or inner shell 25 to each other, or for anchoring the outer shell 23 to the ground, with FIG. 1 being a skeletal view to show the nested relationship of the outer shell 23 and inner shell 25. Differing construction materials and methods of support, such as positive air pressure and the like, can be used to construct the desalination greenhouse 21. Supports 51 may include any frame member, as well as any member from which external or internal support may be facilitated by any other structure or object. Also, the desalination greenhouse 21 has been recited in terms of an outer shell 23 and an inner shell 25 such that roof and side cavities 45 and 47 can be available to promote condensation in the outer shell. It is understood that, especially for a desalination greenhouse 21 which is much longer than it is wide, that the ends can be similarly situated to have a side cavities along with some portal access such as a door bridge to extend between them, but that in a long desalination greenhouse 21 most of the action will occur between side cavities 47 of the major long sides of the desalination greenhouse 21, as well as the roof cavities 45.

FIG. 1 illustrates a crude schematic possible location for a pair of air inlet air moving devices such as fans 53 shown, but not necessarily forced to be located nearer the roof 33, and which force outside air into the roof and side cavities 45 and 47. A pair of exhaust or outlet air moving devices, such as fans 55 are shown, but not necessarily forced to be located, in the middle of an end vertical wall structure 57, and connect inner shell 25 inner chamber 43 to the outside atmosphere. Vertical wall structure 57 may include a door 59. The further details of an entry door 59 will be omitted, but suffice it to say that door 59 may be located in a connective portal which engages both the outer shell 23 and inner shell 25 to disrupt any breach or interruption of the roof and side cavities 45 and 47. In this way, a single door 59 can be operated to give access to the inner chamber 41.

Conversely, a separate door may be provided for each of the outer shell 23 and inner shell 25, with the space between the two doors remaining an active part of the roof and side cavities 45 and 47. This may not be as preferred as the opening of either of two such separate doors would disrupt the action and flow going on in the roof and side cavities 45 and 47. When access to the inner chamber 41 is had over a long time, such as the introduction or removal of soil and plant materials, the roof and side cavities 45 and 47 would be significantly disrupted. In yet a further alternative, the end wall 57 may be designed not to contain a side cavity 45 and to be built as a wall and support structure common to both the outer shell 23 and inner shell 25. In this case, the user would give up the desalination action at the end wall 57. However, as can be seen in FIG. 1, and in the end wall 57 and roof portion of end wall 57 supports four fans 53,57 and a door 59, all of which combine to occupy a significant percentage of the end wall 57. It may thus be desirable for simplicity of construction for doors 59 and fans 53, 57 to be located in an isolated cluster which will enable the use of a single wall to thus eliminate the need for double sealing, and accommodating other insulatory structures to enable the action to be described in the roof and side cavities 45 and 47 around such access accommodating and insulatory structures.

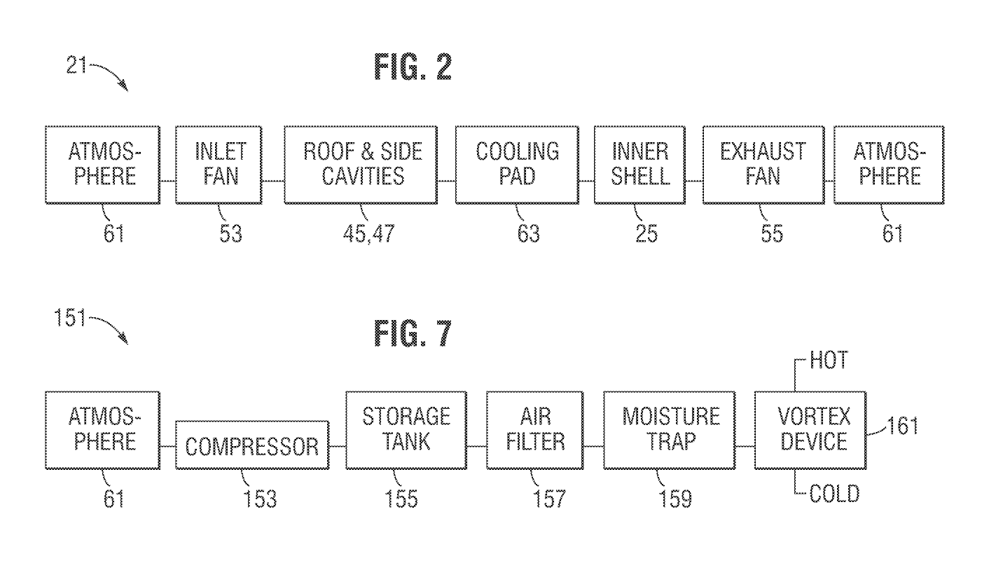

With the basics of an overall structure of an example of the desalination greenhouse 21 having been seen in FIG. 1, and without the need to make duplicative and burdensome specifically located structures to illustrate the operation of the desalination greenhouse 21, a diagrammatic representation of the overall flow is shown in FIG. 2. Referring to FIG. 2, a block diagram illustrates the general flow of air through the desalination greenhouse 21. From the outside atmosphere 61, air may be drawn in through forced air fans 53. Where the desalination greenhouse 21 is much larger than the simple design of FIG. 1, the inside of air fans 53 may be fitted with a distribution duct to insure that the incoming forced air from the atmosphere is spread as evenly as possible through the roof cavity 45, even to the most distant portion of the desalination greenhouse 21. It is understood that even though the general structure of the desalination greenhouse 21 is oblong, that if a desalination greenhouse 21 was wider than long, there may be several forced air fans 53 operating with generally parallel hot air distribution lines (not shown). In the case of a single, extraordinary long desalination greenhouse 21, a large forced air fan 53 might be used with a significant sized ambient air distribution pipe or duct (not shown).

The forced air fans 53 introduce ambient air into the roof and side cavities 45 and 47 throughout the desalination greenhouse 21. The hot air will be utilized to evaporate and possibly cool any saline or brackish water which may be introduced onto the surface of the outside of the inner shell 25. The air circulating in the roof and side cavities 45 and 47 whose humidification may be increased after contact with moisture from the outside of the inner shell 25 may deposit some fresh water droplets via condensation on the inside of the outer shell 23. The air circulating in the roof and side cavities 45 and 47 whose humidification may be increased after contact with moisture from the outside of the inner shell 25 may then proceed into the inside of the inner shell 25 through an optional cooling pad 63. Cooling pad 63 may be a matrixed structure which entrains some liquid to facilitate an increased contact between air circulating in the roof and side cavities 45 and 47 and liquid water which may be present in the cooling pad 63 through a variety of mechanisms.

The cooling pad 63 can be a passive fibrous flow device to enable a passing gas to make a greater degree of contact with a wetted area. Cooling pad 63 can include a recycle branch to collect and recirculate liquid which typically passes through it from top to bottom. Cooling pad 63 may also be connected to external heating sources or cooling sources (not shown in FIG. 2) which provide thermal transfer through a conduit such as a heating coil or cooling coil. Cooling pad 63 also, regardless of whether or not connected to external heating or cooling sources, can act as a stabilizing passive heating or a cooling mass to protect plants within the inner shell 25 from momentary changes such as between full sun and cloud cover, as well as between day and night. Physically, the cooling pad 63 may likely be located within the inner shell 25 and likely beginning at the boundary between the inner shell 25 and the roof and side cavities 45 and 47 and continuing into the inner shell 25 for a sufficient distance (typically horizontal distance) to provide adequate contact between the air flow entering the inner shell 25 and any wetted surfaces within the cooling pad 63.

Air which emerges from the cooling pad 63 enters the inner shell 25 which it is available to humidify and provide gentle and stable appropriate temperature air for any growing plant matter located within the inner shell 25. The air from the cooling pad 63 may be arranged for maximum circulation within the inner shell 25, including other circulating fans, such as ceiling fans and blowers, located within the inner shell 25. From inner shell 25, the air passes to and through exhaust fan 55 and back to the atmosphere 61. It may be preferable for inlet fan 53 to operate at a higher pressure rate than exhaust fan 55 so that the air within the outer shell 23 and inner shell 25 may be somewhat slightly pressurized.

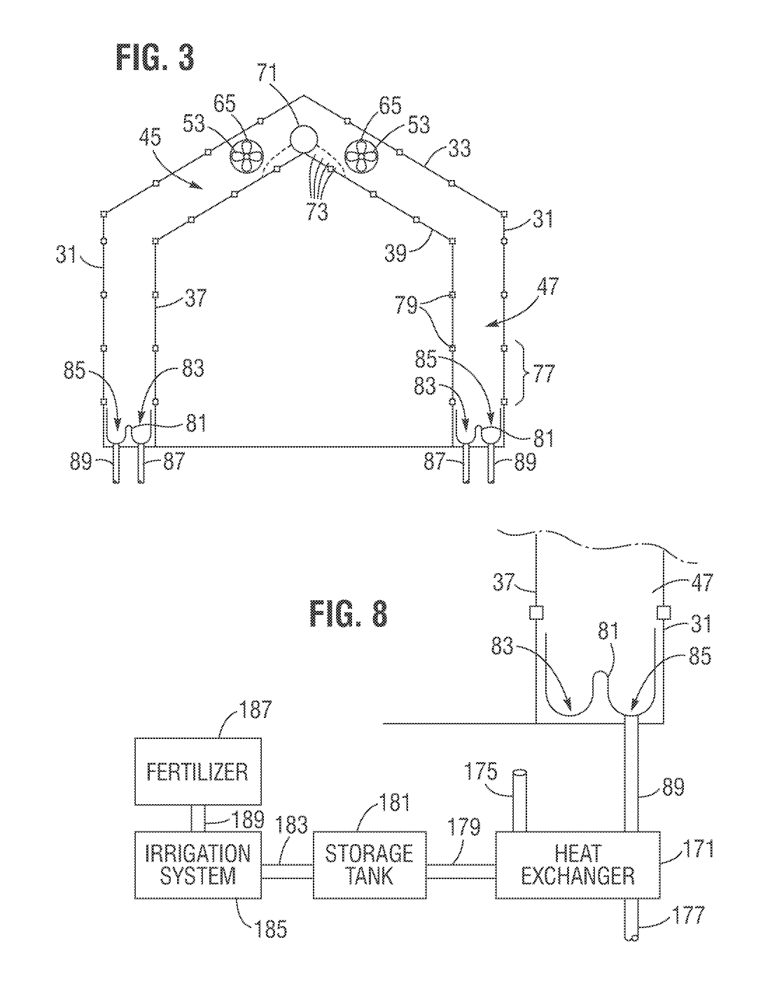

Referring to FIG. 3, a schematic view taken along line 3-3 of FIG. 1 shows some operational details of desalination greenhouse 21. The previously seen inlet fan 53 is seen as blowing air into a conduit or duct 65 which continues to extend along a significant length of the rectangular elongate shape of the desalination greenhouse 21. Duct 65 may be a wide plastic pipe and may be configured to be heated by the sun. The relationship of the roof 33 and roof 39 separated by the roof cavity 45, and the relationship of the vertical walls 31 and vertical walls 37, separated by the wall cavity 47 is better illustrated. Above a top portion of the roof 39, a brine distribution header pipe 71 is seen as having ability to distribute, drip, spray or otherwise convey in any manner, brine 73 in an even as distribution as possible to coat and move slowly across the roof 39 and thence walls 37 of the inner shell 25. As will be shown, the materials of construction of both the inner shell 25 and outer shell 23 are so as to promote an enhanced holding time for brine 73 so that it will have an opportunity to evaporate from the exterior of the inner shell 25 and condense on the inside of the outer shell 23.

Not shown in FIG. 1 were details of construction of the desalination greenhouse 21 as the details of other structures would have been obscured. The materials of construction for the inner and outer shells 25 and 23 of the desalination greenhouse 21 may include a plurality of uprights 77 and cross bars 79 to support panels (not yet shown) which may be replaced if damaged or broken. Uprights 77 and cross bars 79 may be made from galvanized steel, aluminum or other suitable material. In the perspective of FIG. 3, some of the uprights 77 are shown as segments between the cross bars 70 which are shown as expansions located along the uprights 77. It is also noted that the walls 31 and 39 need not be vertical, but may be sloped or curved. Any sloping and curving of the walls 31 and 39 may be configured to combine with the shape of the roofs 31 and 39 to produce an advantageous gravity and slope controlled flow.

Explained, the exterior of inner shell 25 will have an even flow of brackish water or brine 73 over its exterior surface. Any energy input into the inner shell 25 will cause water to be vaporized. Vaporized water may condense on the inside of the outer shell 23 and run down the inside of the roof 33 and down the inside of wall 31. At the base of the walls 37 and 31, the clean condensed water from the inside of wall 31 would otherwise mix with the brackish water, or brine 73 flowing down from the outside of wall 37. The prevention of mixing of these two streams by segregating and conserving the pure condensed water will provide a source of desalinated water. A barrier 81 separates the flow at the base of the walls 31 and 37 into a brackish water reservoir 83 and a fresh water reservoir 85. Brackish water reservoir 83 may have a lower drainage tap 87 and a fresh water reservoir 85 may have a drainage tap 89. Taps 87 and 89 will assist in harvesting and or recycling the brackish water 73 or the condensed water as needed.

Referring to FIG. 4, a panel 91 is shown which has a series of channels or grooves 93 seen in parallel across the upper surface of the panel 91. When the panel 91 is arranged so that the grooves 93 extend horizontally, the grooves act to entrain some of the brackish water 73 and hold onto it while giving it an opportunity to evaporate. At minimum, the grooves 93 increase the effective vertical height of the walls 37 and optionally the flow path length along the roof 39. At best, the grooves 93 could be angled unevenly to form little “shelves” each of which could provide a significant residence time for brackish water 73 on its way to brackish water reservoir 83. In some cases the grooves 93 could even have a negative load flanking to form a horizontal drainage channel with or without interruptions in a horizontal to even further increase the mean flow path. In other words, if every other groove were “nicked” at its end, and if the upper angle were less than horizontal, brackish water 73 could be caused to follow a serpentine path down the panel 91. Other variations are possible.

The panel 91 may be made of conventional greenhouse building material products such as plastic, polycarbonate, or any other material which is at least partially clear. The grooves 93 may be formed by molding or by matching or by other technique. An outer covering may be of lighter materials such as polyethylene for economics and for easy removal when cleaning of the roof 33 is needed. Air and water within the desalination greenhouse 21 may be UV-disinfected at any and at many points in the system to enable the use of an organic crop label for plants grown. Referring to FIG. 5, and as a further variation on panel 91 of FIG. 4, an end view of a panel 101 is shown as having a series of spaced apart and low profile protrusions 103. Likewise, referring to FIG. 6, and as a further variation on panel 91 of FIG. 4, an end view of a panel 111 is shown as having a series of spaced apart and high profile protrusions 133 to form a series of rectangular channels approximately as wide as the protrusions are tall.

The use of a vortex system could be employed with the desalination greenhouse 21. Referring to FIG. 7, a schematic block diagram of such a system is shown. A vortex system 151 includes equipment to make a process flow of air. A vortex diverter system 151 is used for heating on one end and cooling on the other and which may be controlled to increase or decrease as required. A compressor 153 pressurizes air into an air storage tank 155 at about 100 PSI. The pressurized air exits from the tank 155 and passes through an air filter 157 and a moisture trap 159 before it inters a vortex device 161. The vortex device 161 splits the air into cold stream exiting from one end of the vortex device 161 and hot exiting from the other end of the vortex device 161. The hot air output of the vortex device 161 may be introduced into the duct 65 either upstream or downstream of the inlet fans 53 where it will ultimately enter the roof and side cavities 45 and 47. The cold air output of the vortex device 161 may be passed through a coil or other heat exchange structure inside a water pipe (not shown) carrying the cold water to the inner shell 25 of the desalination heat exchanger 21. In the summer when more cold air from the output of the vortex device 161 is needed to condense more water, the cold portion of the air is increased which will decrease the warm output of the vortex device 161. In winter the arrangement is reversed as more hot air from the vortex device 161 is needed for introduction of heated air duct 65 either upstream or downstream of the inlet fans 53. Mechanical controls on each end of the vortex device 161 outlets facilitate adjustment of heat and cold flow. In instances when the air filter 155, and heat and residence time in the vortex system 151 do not disinfect enough, the air passing into black, heat absorbing conduit or duct 65 can provide some additional sterilization.

In general, the use of a vortex system could be employed with the desalination greenhouse 21. The cool air under positive pressure from the air blower 153 will eventually enter inner shell 25 through evaporation or cooling pads 63. Cooling pads 63 may be switched off by either being taken out of the path of flow or simply allowed to run dry, to remove its ability to cool inner shell 25 of desalination greenhouse 21 using cooled air from roof and side cavities 45 and 47. Conversely, cooling pads 63 may be switched on or into or out of the path of flow and with the brine distribution header pipe 71 used for wetting roof 39 and side walls 37 of inner shell 25 of desalination greenhouse 21 with roof and side cavities 45 and 47 switched off or isolated from flow, in humid climates so that heating the air reduces its relative humidity and makes it effective in cooling inner section 24 of desalination greenhouse 21. Cool air then passes from roof and side cavities 45 and 47 into inner shell 25 of desalination greenhouse 21 to cool the growing crop, to enable the growing crop to transpire, to supply oxygen and to remove carbon dioxide and other gases. Air becomes warmer and more humid as it passed from one end of to the other of inner shell 25 of desalination greenhouse 21 due to the incident light and heat and transpiration of the crop in inner shell 25 of desalination greenhouse 21. Air may exit inner shell 25 of desalination greenhouse 21 through a heat exchanger (not shown in FIG. 7) through which cold water is circulated. The air loses its moisture to heat exchange and exits to ambient environment or fed to the inlet of the inlet fan 53 feeding roof and side cavities 45 and 47. An advantage of circulating air is to reduce dust and germ, insects, seed and other undesirable foreign matter into desalination greenhouse 12. Ultra-violet disinfectant 80 helps classify a crop as organic since no chemical disinfectants or herbicides were used.

Referring to FIG. 8, a portion of a possible flow scheme utilizable in conjunction with the desalination greenhouse 21 is shown. A section including the inner shell 25, outer shell 23 and barrier 81 is shown with a connection to drainage tap 89. Drainage trap 89 can be connected into a heat exchanger 171 which can be used to dehumidify the humid warm air exiting inner shell 25 before being discharged to atmosphere. An air inlet 175 is shown and which may optionally be connected either upstream or downstream of the exit fan 55 seen in FIG. 1. An air outlet 177 would typically be vented directly to atmosphere 61. A number of shutoff and bypass valves, storage tanks and piping (not shown) may be used to shutoff and bypass water flow to any of the devices when not in use and store water.

Heat exchanger 171 exit condensate is preferably collected through exit line 179 and is piped to an insulated underground cold water storage tank 181. A portion of the desalinated water is transferred by pipe 183 to an insulated underground irrigation tank 185 tank used as an irrigation reservoir. Well balanced fertilizers that include macro and micro nutrients required by the crops may be contained in a fertilizer tank 187 and dosed into the irrigation tank and are topped as the crop uses the fertilizers through a dosing line 189. One possible method of hydrating the plants may involve cold irrigation water fed to the crop through piping that connects to soaker hoses laid in parallel under the crop. Excess irrigation water may be drained to the irrigation system tank 185 which is topped with fertilizers and desalinated water as needed.

Referring to FIG. 9, a stack of two growing trays, including growing tray 201 and growing tray 203 are shown in stacked relationship to emphasize the efficiency which can be achieved in conjunction with the desalination greenhouse 21. The growing trays 201, 203 contain the sprouted seeds to grow the crop. The growing trays have edges 205 which may overlap so as to contain irrigation water within the trays 201,203. Trays 201, 203 may each have a drainage hole 207 and several openings 209 to admit light to promote growth even though the trays 201,203 may be in stacked position. One set of dimensions that may work well for a given growing tray 201 may include a width of about 100 centimeters, a depth of about 120 centimeters, and a depth of about 40 centimeters.

The growing trays 201, 203 may also extend along the same direction as a soaker hose 211. Soaker hoses 211 may extend along the length of the desalination greenhouse 21 and may be fed with cold water from fertilizer added irrigation system 185 seen in FIG. 8. Several soakers hoses 211 may connect to a header for pressure equalization. Soaker hoses 211 may also deliver a desalinated water rich in nutrients in the form sprayed fog. Irrigation frequency is scheduled to provide the crop with adequate irrigation water, without excess, during, for example, a 10-14 day growth cycle, for forage production. Using the growing trays 201, 203 shown and soaker hose 211 shown, the root mat for plants grown in soil-less culture will be removed with the crop during harvest.

In terms of overall process operations, the water for feeding crops is typically the desalinated water which originates at the inside surface of the outer shell 23 of the desalination greenhouse 21 resulting from evaporating of sprayed brackish water 73 using relatively hot air within roof and side cavities 45 and 47 and producing, condensation of inside of roof 33 and sides 31 of desalination greenhouse 21 resulting from evaporation of sprayed brackish water 73 onto the roof 39 and walls 37 of the inner shell 23 of the desalination greenhouse 21 and possibly from cooling pads 63 when operating, and from evapo-transpiration of the crop. Condensate from vertical walls 31 of the outer shell 23 are collected in a fresh water reservoir 85 which is preferably separated from a brackish water reservoir 83 such as by a barrier 81 as was shown in FIG. 8. Desalinated water may be collected in an insulated underground storage tank 181 and utilized both for crop watering and as a source of fresh water.

In terms of process, and in further detail as to operation, air forced by inlet fans 53 are distributed evenly throughout the roof and side cavities 45 and 47. When this air is heated, it evaporates sea or brackish water 73 on the exterior surface of the inner shell 25. Downward flow of brackish water 73 is delayed by grooves 93, 103 or 113 of panel 91, 101, 111 which make up the roof 39 and side outer surfaces of vertical walls 37, except for doors 59 and vents associated with the inlet and exit fans 53 and 55. Transparent roof 33 of outer shell 23 of the desalination greenhouse 21 preferably passes maximum light and heat to roof and side cavities 45 and 47. Roof 39 and vertical sides 37 of inner shell 25 of desalination greenhouse 21 is wetted with a thin sheet of brackish water 73, of about two centimeters or less thick, fed from a source of sea or brackish water 73 from brine distribution header pipe 71 by a low pressure pump and spread evenly as guided by grooves 93, 103 or 113 of panel 91, 101, 111. Cool air from to roof and side cavities 45 and 47 is produced by hot air giving up its heat to vaporize water, especially where brackish water 73 is heated in a black lining sun exposed section of the outer section of the desalination greenhouse 21. As inlet air is heated its relative humidity drops. It then passes through the cooling pads 63 where it may pick up more moisture and cools the inner shell 25 of desalination greenhouse 21. Brackish water 73 on the roof 39 of inner shell of desalination greenhouse 21 is cooled through evaporation and transmits this cooling effect through panel 91, 101, 113 to the inner shell 23 of desalination greenhouse 21 to aid in the cooling of the crop environment and condensation of moisture on the inside of the outer section 23 of the desalination greenhouse 21. Cool air is blown into inner chamber 43 through the cooling pads 61.

When roof 39 of the inner shell 25 is not wetted, as in winter when crop water requirement and cooling are not required, hot air passes through water soaked cooling pads 61 to pick up moisture to produce cool air within inner chamber 43 and to produce cold water where a coil is provided in the cooling pad 61. Cool air will then exit evaporative cooling pads 61 into the inner chamber 43 of the inner section 25 of the desalination greenhouse 21 to cool growing crops and then exit through exhaust fans 55 which operate at lower pressure than forced air fans 53 to maintain positive pressure in both the inner chamber 43 and the roof and side cavities 45 and 47. In the alternative, exhaust fans 55 can be minimized or eliminated with certain designs, particularly a passive exit where overall pressure and air flow in the desalination greenhouse 21 is maintained high.

The forage crop production system in the desalination greenhouse 21 is and can be a 24/7 production system. A quantity of the seeds, depending on the size of the growing tray 201, may be soaked in disinfected water for 24 hours, then drained and covered to germinate in a pail or other container. The seeds may be irrigated with mist nutrient twice a day. Within 3-4 days the germinated seed may be spread in a growing box such as growing tray 201 and placed on a conveyer belt or rollers. The growing trays 201 may be stacked 4-6 high to utilize the inner chamber 43 of the desalination greenhouse 21 effectively. The growing trays 201 may have openings 207 on the sides for light, ventilation and irrigation. The growing trays 201 may be irrigated with a mist of nutrient rich desalinated water. A conveyor belt or roller (not shown) can be operated daily to move ⅛ to 1/10 the distance per day so that a crop has an automated harvest indication each day after it has been on this type of moving belt for 8 to 10 days.

The crop, including the roots, may be tipped from the growing tray 201 and into a tub grinder which may cut or otherwise process the crop and feeds it into a wagon or conveyance to be transported fresh to its needed consumption point, such as to a grazing animals for feeding. A typical desalination greenhouse if 500 square meters area and net production area 300 square meters, will produce 4 tons of barley forage per day. It will use 50 cubic meters of sea or brackish water per day compared to 10,000 cubic meters per day in field production of sweet water. The energy requirement is 96 KWH per day for the fans and pumps. Conventional Reverse Osmosis desalination alone will require 200-400 KWH per day for the same flow rate.

Controls of the desalination greenhouse 21, not shown, may be used to control the equipment set forth and other equipment. Equipment controlled includes ventilation, evaporative cooling, spraying and use of both fresh and brackish water, irrigation, vortex device 161 operation, warning systems, pumps, bleeding of brine, brine evaporation and other functions. The advantages of desalination greenhouse 21 are to desalinate brackish water 73 for potable and agricultural use and to insulation property of two preferably transparent bodies, as the bulk of the internal and external shells 25 and 23, with air in between within roof and side cavities 45 and 47 which enables a level of control and combines to save major running expenses compared to conventional greenhouse operation. The brine distribution header pipe 71 sprinkling system within the roof and side cavities 45 and 47 creates a sheet of water on the roof 39 and vertical walls 37 of inner shell 25 of desalination greenhouse 21 further insulating it without obstructing light transmission and while cooling inner chamber 43 of desalination greenhouse 21. The superior properties of water to absorb heat to the extent of 540+ calories per cubic centimeter (cc) when evaporating is an effective cooling mechanism in summer while the outer shell 23 of desalination greenhouse 21 insulates it from cold and snow in winter. Such arrangement exemplified in the desalination greenhouse 21 saves energy and is environmentally friendly.

Another advantage of desalination greenhouse 21 is the use of the crop growing structure of inner shell 25 of desalination greenhouse 21 as a support structure for the cover of inner shell 25 of desalination greenhouse 21. Cooling of crop roots using soaker hoses 211 is another advantage of desalination greenhouse 21 for the crop shoots to be enabled to tolerate higher temperatures in their potentially high temperature growing environment. An additional advantage of desalination greenhouse 21 is the ability for sterilization of the air through heat and ultraviolet treatment which enables desalination greenhouse 21 to grow organic crops and reduce insecticide use. A further advantage of desalination greenhouse 21 is use of natural lighting while providing a general thermal insulated inner section 25 of desalination greenhouse 21.

Another advantage of desalination greenhouse 21 is the heating of air for use for effective evaporative cooling where it would otherwise be ineffective in humid areas. A further advantage of the desalination greenhouse 21 is the flexibility and efficiency of using many features independently, especially heating and cooling which contributes to an overall cost reduction. A further advantage of the desalination greenhouse 21 is the use of renewable energy for some or all of its operations. The aforementioned advantages make the desalination greenhouse 21 simple to operate and competitive especially in developing countries where fuel is expensive and potable water may not be available and where animal husbandry is a major economic activity for millions of people. Another advantage of using forage for desalination is that the high water content of fresh forage is used to partially or totally meet the water requirement of animals and thus make more desalinated water available to potable use.

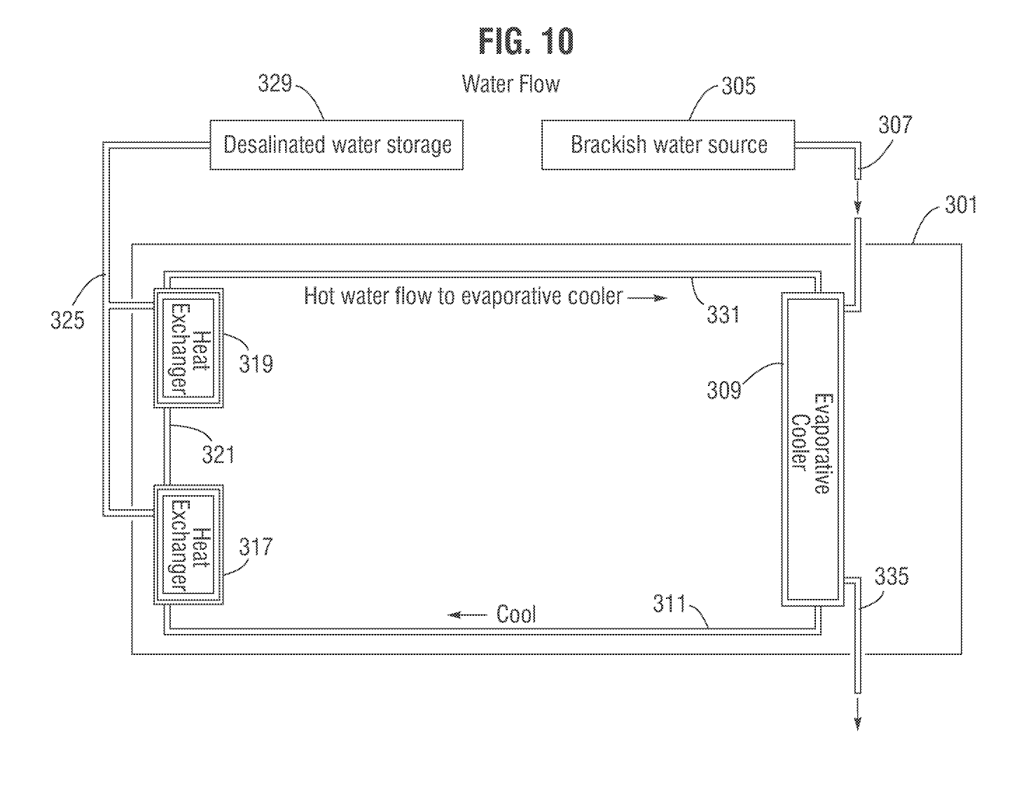

Referring to FIG. 10 a schematic seen as a water flow schematic for a further embodiment of a solar desalination greenhouse labeled 301 which may preferably employ a growing crop both for economic crop production and to produce potable water, the water flow schematic shown without air flow for simplicity of explanation. In the schematics and drawings that follow, the solar desalination greenhouse 301 is shown in rectangular form as a floor plan or footprint on land. The shape of the solar desalination greenhouse 301 it may appear to give a good advantage by naturally providing a long path through which air may travel to achieve a high gradient (moisture or temperature) after time spent in process. Nothing will necessarily inhibit the use of a different configuration, or of an internal configuration that may be subdivided, or serpentine or the like.

A brackish water source 305 may be a storage tank or a pump or other source of flowing brackish water which will be available to the inside boundary of the solar desalination greenhouse 301. The brackish water source 305 is provided via a supply line 307 to an evaporative cooler 309 which may be a falling liquids air contactor or may be evaporative pads, or any similar structure that will enable the brackish water from the brackish water source 305 to have contact with low humidity air to humidify the air and lower the temperature of both the brackish water and to lower the temperature of the low humidity air as such low humidity air becomes high humidity air. (Within the evaporative cooler 309 may be any number of a series of cascading contact units as well as a cascade of cooled brackish water so that the lowest temperature of brackish water can be supplied in a cool water flow line 311 to heat exchangers 317 and 319. (The operation of the evaporative cooler 309 works on the same principle as so-called “swamp coolers” in arid regions where hot, low humidity air is contacted with recycled water which causes a temperature reduction in both the water and the humidified air).

Heat exchangers 317 and 319 use the cool water flow line 311 that likely contains brackish water of somewhat more concentrated due to the loss of water content to supply humidity to the incoming hot air at the evaporative cooler 309. The cooling capacity of the cool water in flow line 311 is used to condense water from humid cool air before it leaves the solar desalination greenhouse 301. The heat exchangers 317 and 319 are schematically shown near the end of the desalination greenhouse 301 in order that water content not be removed from air that might still be capable of circulating within the confines of the desalination greenhouse 301, and that might cause loss of moisture from any growing crop within desalination greenhouse 301. Although simplistically shown, the degree of contact, efficiency and steps to maximize condensation are contemplated in any physical realization of the heat exchangers 317 and 319 and their contact with air. An intermediary line 321 may consist of multiple lines that may balance the amount of cooling between the heat exchangers 317 and 319 where needed.

From the heat exchangers 317 and 319, possibly through a drip-pan mechanism, a set of condensate drainage lines 325 are used to transport desalinated water to a desalinated water storage tank 329. In addition, any condensation that occurs on other structures of the solar desalination greenhouse 301, such as walls and ceiling of the greenhouse, is collected in gutters attached to the bottom of the greenhouse walls and is also piped to storage. Some of the desalinated water may be used to assist in growing any crops that may be present as well as to support the operations at the greenhouse 301. Once the cool water in flow line 311 has passed through the heat exchangers 317 and 319 the water will gain heat and return via a flow line 331 and back to the evaporative cooler 309 where it will provide a source of closed loop brackish water to have contact with low humidity air to humidify the air and lower the temperature of both the brackish water and the low humidity heated air. Any shortfall in the recycled heated water will be made up with water from the brackish water source 305 through supply line 307.

The recycle warmed brackish water via a flow line 331 will be of lower water content than the brackish water source 305 through supply line 307. Removal of the higher salt concentration brackish water from the flow line 331 will preferably occur before any shortfall in the recycled heated water will be made up with water from the brackish water source 305 through supply line 307. The water flow system of FIG. 10 may either have some batch capacity to periodically rid itself of higher concentration brackish water before brackish water source 305 through supply line 307, or the higher salt concentration brackish water from the flow line 331 may be continuously bled off through an internal line of the evaporative cooler 309. A high concentration brine bleed line 335 may lead to a storage tank or directly to another location for further processing. The brine which exits the evaporative cooler 309 may preferably be bled to maintain a reasonable concentration, (such as >250,000 ppm for example) and could now be harvested through Salt Brine Capillary Crystallization process or other process to concentrate salt.

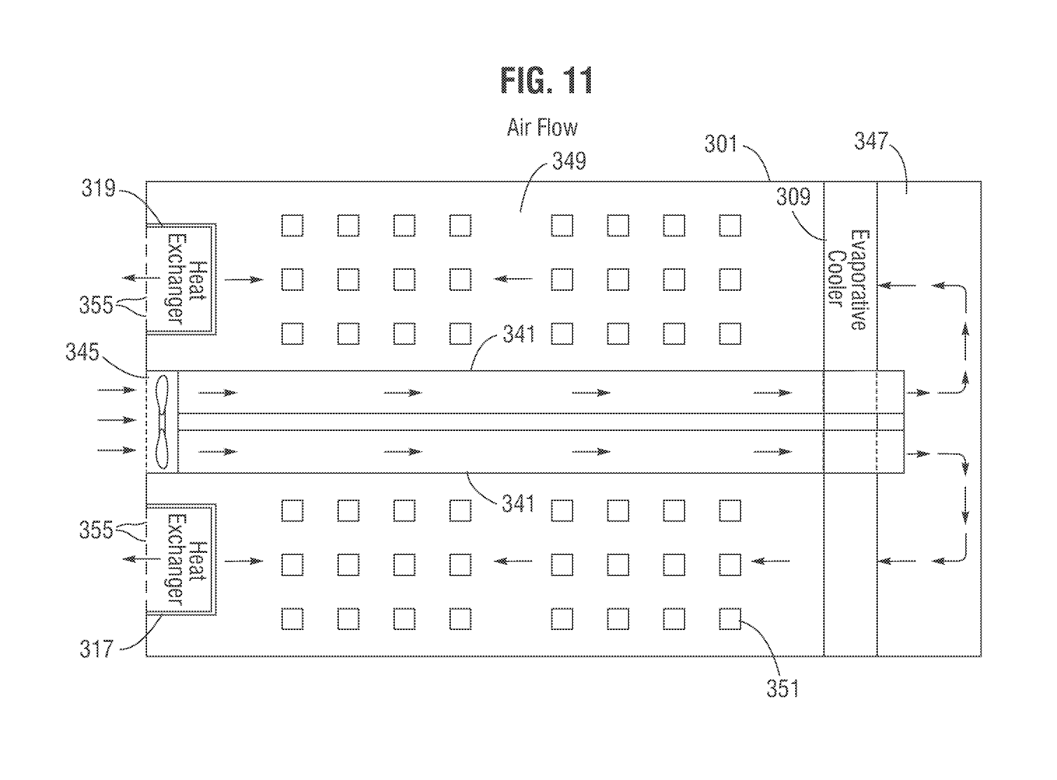

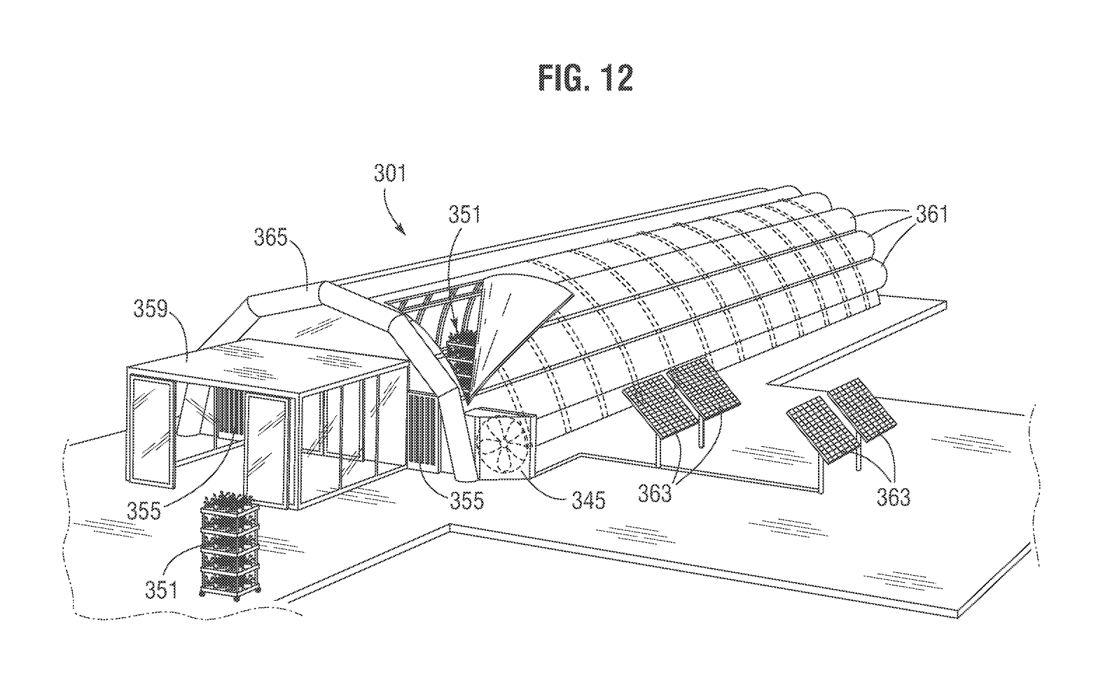

Referring to FIG. 11, an air flow schematic for the further embodiment of a solar desalination greenhouse seen in FIG. 12 is shown. The solar desalination greenhouse 301 has the same boundary seen in FIG. 11. One preferred embodiment of the greenhouse 301 as having a length longer than its width takes advantage of this configuration to include air intake flow ducts 341 and extending predominantly along its length and in a position to insure solar contact and a naturally longer residence time for heating so that a higher temperature, lower relative humidity air can be used as an air side feed for the evaporative cooler 309. Although only two air intake flow ducts 341 are shown in the schematic for simplicity of explanation, a plurality of such ducts are preferably used. Where the greenhouse 301 uses an outer material which can benefit from pressurized air flow, an inlet fan 345 may be positioned just ahead of an entry to the air intake flow ducts 341 to also assist in inflation and surface shape support.

Hot, low humidity air that exits the air intake flow ducts 341 may enter a collection space 347 before being forced through the air humidification and cooling side of the evaporative cooler 309 before being introduced into an inside atmosphere 349 of the greenhouse 301 where a plurality of crop modules 351 will be exposed to a cooled, high humidity, preferably light-rich environment. As the cooled moist air now enters the greenhouse and under force of various other forms of ventilation equipment that may be employed, the moist cooled air picks up heat from the inside atmosphere 349 of the greenhouse 301 and additional moisture from the bio-product, or crop growing in the inside the greenhouse such as Salicornia which is normally irrigated directly with seawater or barley which is brackish water tolerant (which saves more potable water for other uses). The crop is seen as crop modules 351 that may preferably be a series of stacked containers to enable more efficient vertical space usage of the solar desalination greenhouse 301 and that may be easily arranged. The presence of bio-product or crop modules 351 further ensure that the air maintains humidity saturation as it gets hotter from light and heat entering the greenhouse. The environmental contact between the crops of the crop modules 351 will help in maintaining a high humidity environment within the greenhouse 301 and thus enables a higher yield of desalinated water from the heat exchangers 317 & 319.

FIG. 11 shows a generalized longitudinal entry path and exit path, but other paths that may be more serpentine can be designed to meet different objectives. In addition, the air intake flow ducts 341 may be provided in such numbers that they completely surround the major extent of the top and sides of solar desalination greenhouse 301 subject to the goal of allowing light entry sufficient for the type of crop module 351 being grown. Inlet fan 385 blows arid ambient air through the air intake flow ducts 341 with restricted exit openings to keep the conduits fully inflated. Ideally, the solar thermal energy falling on the air intake flow ducts 341 and reflected by a near infra-red (NIR) greenhouse inner skeleton will reflectively increase the temperature of the air as it passes through them. Crop modules 351 may be moveable within, and moveable in and out of the solar desalination greenhouse 301 for greater ease of harvesting, movement and ordering for maximum efficiency. The heat exchangers 317 & 319 are shown as being located near the greenhouse 301 boundary, but need not be. Moisture saturated air enters the heat exchangers 317 & 319 to have as much moisture condensed as possible before the air exits to the atmosphere through an openings section 355 at the greenhouse 301 boundary.

Referring to FIG. 12, a perspective partially broken-away view of the solar desalination greenhouse 301 of the invention is shown. A series of internal curved structural supports may support a polymeric covering that has a series of scalloped structural members 361 what may extend the length of the greenhouse 301 and may contain the air intake flow ducts 341 previously seen in schematic FIG. 11, as will be shown in further detail. A main end support and supply duct 365 may provide stability to the whole greenhouse structure and may also form part of the flow path of the air intake flow ducts 341 previously seen in schematic FIG. 11, but not seen in FIG. 12. Other supports and other ducts can supplement the end support and supply duct 365. The fan 345 is shown in a position to draw outlet air into the inside of the solar desalination greenhouse 301.

As was seen in the schematics of FIGS. 10 and 11, it may be efficient for some oblong structures to have the air entry and exit at one end of the greenhouse 301. Openings section 355 is seen space apart from the fan 345. The heat exchangers 317 & 319 may be expected to be located behind the openings section 355. A broken away section illustrates a plurality of plurality of crop modules 351 shown in a stacked orientation. One of the crop modules 351 is shown outside an ante room 359 that help in keeping the inside of the greenhouse 301 continuously under pressure during the time when crop modules 351 are moved into and out of the greenhouse 301. Also seen are sets of solar panels 363 that are appropriately placed for maximizing solar power advantage.

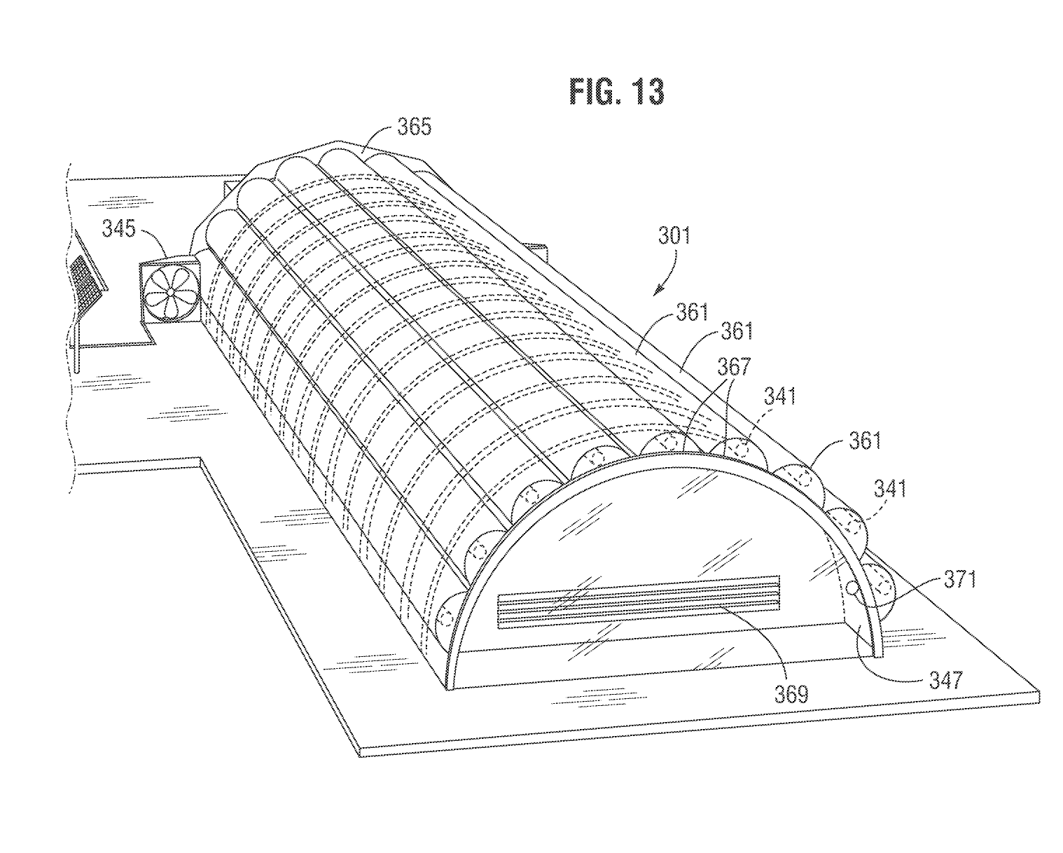

Referring to FIG. 13, a perspective view of the solar desalination greenhouse 301 as was seen in FIG. 12 is shown from the other side to illustrate further features. The series of scalloped structural members 361 are seen to provide an upper part of a space to hold the air intake flow ducts 341, shown in broken line format because they do not have fluid communication with the exterior of the greenhouse 301. Scalloped structural members 361 and a lower layer 367 effectively encapsulating the air intake flow ducts 341 into a concentrating solar reflective chamber. Lower layer 367 also helps to keep the inside atmosphere 349 of the greenhouse 301 cooler. Also seen in FIG. 13 is the collection space 347 with the end wall of the greenhouse 301 being transparent or removed. From the angle of the perspective of FIG. 13 one of a number of exit ports 371 is seen that enables fluid communication between the ducts 341 and the collection space 347 that enables the hot low humidity air to enter the collection space 347 before exiting into an entrance 369 of the evaporative cooler 309 (not wholly seen in FIG. 13).

An important aspect of the solar desalination greenhouse 301 that will increase its usage is its economic advantage when used with a growing crop. The data and some computation as to the operation of a solar desalination greenhouse 301 having a height of four meters, a length of twenty meters and a width of fifteen meters, and thus which occupies a footprint of three hundred square meters production area is presented. The water production figures are based upon an evaporative cooler, solar greenhouse or SDG operating at 80 percent efficiency. At an airflow rate of 28.32 m³/min, a 5.56° C. difference between wet bulb and dry bulb temperature yields 3.79 liters of water every hour. Table I gives some background data comparable with some of the more severe arid regions where the solar desalination greenhouse 301 may be employed, using data from Dhahran Saudi Arabia. Table II, following Table I uses some of the data of Table I in calculating a likely level of water production.

TABLE I
Ambient Climate Data for Dhahran, Saudi Arabia

| | | | | | | | | | | | |
|---|---|---|---|---|---|---|---|---|---|---|---|
| Jan | Feb | Mar | Apr | May | Jun | Jul | Aug | Sep | Oct | Nov | Dec |

Dry Bulb Temp (Air entering heating chutes) T_{db}

| | | | | | | | | | | | |
|---|---|---|---|---|---|---|---|---|---|---|---|
| 15 | 16 | 20 | 25 | 31 | 34 | 35 | 35 | 32 | 28 | 32 | 17 |

Average temperature of air on contact with water (T_{bdh)}

| | | | | | | | | | | | |
|---|---|---|---|---|---|---|---|---|---|---|---|
| 15 | 16 | 20 | 25 | 31 | 34 | 35 | 35 | 32 | 28 | 22 | 17 |

Humidity of Heated Air (RHₕₐ₎

| | | | | | | | | | | | |
|---|---|---|---|---|---|---|---|---|---|---|---|
| 70 | 65 | 55 | 45 | 35 | 35 | 35 | 45 | 50 | 60 | 65 | 70 |

New Wet Bulb Temp (T_{wbh)}

| | | | | | | | | | | | |
|---|---|---|---|---|---|---|---|---|---|---|---|
| 23.30 | 24.40 | 26.20 | 30.20 | 35.00 | 39.70 | 39.00 | 42.60 | 42.60 | 40.00 | 32.33 | 25.00 |

Wet Bulb Temp (T_{wb)}

| | | | | | | | | | | | |
|---|---|---|---|---|---|---|---|---|---|---|---|
| 11.89 | 12.23 | 14.42 | 16.98 | 19.66 | 21.88 | 22.62 | 24.95 | 23.57 | 22.01 | 17.52 | 13.70 |

Average Relative Humidity (RH)

| | | | | | | | | | | | |
|---|---|---|---|---|---|---|---|---|---|---|---|
| 70 | 65 | 55 | 45 | 35 | 35 | 35 | 45 | 50 | 60 | 65 | 70 |

Absolute Humidity (g/kg)

| | | | | | | | | | | | |
|---|---|---|---|---|---|---|---|---|---|---|---|
| 10.64 | 11.36 | 14.69 | 20.07 | 28.86 | 34.48 | 36.56 | 36.56 | 30.64 | 24.08 | 16.67 | 12.12 |

Dew Point Temperature

| | | | | | | | | | | | |
|---|---|---|---|---|---|---|---|---|---|---|---|
| 8 | 10 | 11 | 12 | 13 | 13 | 16 | 17 | 19 | 17 | 14 | 11 |

Atmospheric Pressure (bar)

| | | | | | | | | | | | |
|---|---|---|---|---|---|---|---|---|---|---|---|
| 1.013 | 1.013 | 1.013 | 1.013 | 1.013 | 1.013 | 1.012 | 1.013 | 1.013 | 1.013 | 1.013 | 1.013 |

Saturation Vapor Pressure (mbar)

| | | | | | | | | | | | |
|---|---|---|---|---|---|---|---|---|---|---|---|
| 17.05 | 18.18 | 23.39 | 31.69 | 44.96 | 53.24 | 56.28 | 56.29 | 47.59 | 37.82 | 26.45 | 19.38 |

Partial Vapor Pressure (mbar)

| | | | | | | | | | | | |
|---|---|---|---|---|---|---|---|---|---|---|---|
| 11.94 | 11.82 | 12.86 | 14.26 | 15.74 | 16.83 | 19.70 | 25.33 | 23.79 | 22.69 | 17.19 | 13.57 |

Humidity Ratio (moisture/air)(kg/kg)

| | | | | | | | | | | | |
|---|---|---|---|---|---|---|---|---|---|---|---|
| 0.007 | 0.007 | 0.008 | 0.009 | 0.010 | 0.012 | 0.012 | 0.016 | 0.015 | 0.014 | 0.011 | 0.008 |

Enthalpy (KJ/kg)

| | | | | | | | | | | | |
|---|---|---|---|---|---|---|---|---|---|---|---|
| 33.84 | 34.67 | 40.01 | 47.75 | 56.25 | 64.04 | 66.80 | 76.07 | 70.44 | 64.51 | 49.40 | 38.47 |

Specific Volume (m³/Kg)

| | | | | | | | | | | | |
|---|---|---|---|---|---|---|---|---|---|---|---|
| 0.83 | 0.823 | 0.84 | 0.86 | 0.87 | 0.89 | 0.89 | 0.89 | 0.88 | 0.87 | 0.85 | 0.83 |

Average Daily Solar Radiation - Direct (MJ/m²)

| | | | | | | | | | | | |
|---|---|---|---|---|---|---|---|---|---|---|---|
| 17.8 | 19.8 | 19.7 | 21.7 | 26.3 | 30.7 | 27.6 | 27.5 | 28.0 | 25.7 | 20.4 | 16.9 |

Average Hours Of Daylight Per Day

| | | | | | | | | | | | |
|---|---|---|---|---|---|---|---|---|---|---|---|
| 11.1 | 11.7 | 12.4 | 13.2 | 13.9 | 14.2 | 14.0 | 13.4 | 12.7 | 11.9 | 11.3 | 10.9 |

Average Solar Radiation Per Second (kJ/sec/m²)

| | | | | | | | | | | | |
|---|---|---|---|---|---|---|---|---|---|---|---|
| 0.45 | 0.47 | 0.44 | 0.46 | 0.53 | 0.60 | 0.55 | 0.57 | 0.61 | 0.60 | 0.50 | 0.43 |

Days per month

| | | | | | | | | | | | |
|---|---|---|---|---|---|---|---|---|---|---|---|
| 31 | 28 | 31 | 30 | 31 | 30 | 31 | 31 | 30 | 31 | 30 | 31 |

Average Wind Speed (km/h)

| | | | | | | | | | | | |
|---|---|---|---|---|---|---|---|---|---|---|---|
| 14 | 19 | 20 | 20 | 22 | 27 | 25 | 22 | 19 | 17 | 14 | 16 |

Thermal Conductivity of Air (W/m · k)

| | | | | | | | | | | | |
|---|---|---|---|---|---|---|---|---|---|---|---|
| .02535 | .02542 | .02570 | .02605 | .02647 | .02668 | .02675 | .02675 | .02654 | .02626 | .02584 | .02549 |

Specific Heat Capacity (Kj/kg · K)

| | | | | | | | | | | | |
|---|---|---|---|---|---|---|---|---|---|---|---|
| 1.005 | 1.005 | 1.005 | 1.005 | 1.005 | 1.005 | 1.005 | 1.005 | 1.005 | 1.005 | 1.005 | 1.005 |

Kinematic Viscosity (m²/s)

| | | | | | | | | | | | |
|---|---|---|---|---|---|---|---|---|---|---|---|
| 1.47E07 | 1.48E07 | 1.51E07 | 1.56E07 | 1.61E07 | 1.64E07 | 1.65E07 | 1.65E07 | 1.62E07 | 1.59E07 | 1.53E07 | 1.49E07 |

Expansion Coefficient (1/K)

| | | | | | | | | | | | |
|---|---|---|---|---|---|---|---|---|---|---|---|
| 3.49E03 | 3.48E03 | 3.44E03 | 3.38E03 | 3.31E03 | 3.27E03 | 3.26E03 | 3.26E03 | 3.29E03 | 3.34E03 | 3.41E03 | 3.47E03 |

Prandtl's Number

| | | | | | | | | | | | |
|---|---|---|---|---|---|---|---|---|---|---|---|
| 0.714 | 0.713 | 0.713 | 0.713 | 0.712 | 0.712 | 0.712 | 0.712 | 0.712 | 0.712 | 0.713 | 0.713 |

Density of Air (kg/m³)

| | | | | | | | | | | | |
|---|---|---|---|---|---|---|---|---|---|---|---|
| 1.216 | 1.211 | 1.194 | 1.174 | 1.150 | 1.138 | 1.133 | 1.131 | 1.143 | 1.158 | 1.184 | 1.207 |

TABLE II
Computation of Water Produced using a 5.56° C. constant.

| | | | | | | | | | | | |
|---|---|---|---|---|---|---|---|---|---|---|---|
| Jan | Feb | Mar | Apr | May | Jun | Jul | Aug | Sep | Oct | Nov | Dec |

Dry Bulb Temp (Heated Air Maximum Temperature Exiting Inlets) T_{db}

| | | | | | | | | | | | |
|---|---|---|---|---|---|---|---|---|---|---|---|
| 38.31 | 41.33 | 44.10 | 52.11 | 62.84 | 70.71 | 68.59 | 69.83 | 69.05 | 63.81 | 51.40 | 40.27 |

New Wet Bulb Temp (T_{wbh)}

| | | | | | | | | | | | |
|---|---|---|---|---|---|---|---|---|---|---|---|
| 23.30 | 24.40 | 26.20 | 30.20 | 35.00 | 39.70 | 39.00 | 42.60 | 42.60 | 40.00 | 32.33 | 25.00 |

Dry Bulb Temperature − Wet Bulb Temperature

| | | | | | | | | | | | |
|---|---|---|---|---|---|---|---|---|---|---|---|
| 15.61 | 16.93 | 17.90 | 21.91 | 27.84 | 31.01 | 29.59 | 27.23 | 26.45 | 23.81 | 19.07 | 15.27 |

Dry Bulb Temperature − Wet Bulb Temperature/5.56° C. constant

| | | | | | | | | | | | |
|---|---|---|---|---|---|---|---|---|---|---|---|
| 2.81 | 3.04 | 3.22 | 3.94 | 5.01 | 5.58 | 5.32 | 4.90 | 4.76 | 4.28 | 3.43 | 2.74 |

m³ of water/hr based upon an airflow rate of m³/min per 5.56° C. difference

| | | | | | | | | | | | |
|---|---|---|---|---|---|---|---|---|---|---|---|
| 1.01 | 1.10 | 1.16 | 1.42 | 1.81 | 2.01 | 1.92 | 1.77 | 1.72 | 1.55 | 1.24 | 0.99 |

m³ of water/day

| | | | | | | | | | | | |
|---|---|---|---|---|---|---|---|---|---|---|---|
| 24.33 | 26.38 | 27.89 | 34.14 | 43.38 | 48.32 | 46.12 | 42.44 | 41.22 | 37.11 | 29.71 | 23.78 |

m³ of water/month

| | | | | | | | | | | | |
|---|---|---|---|---|---|---|---|---|---|---|---|
| 754.29 | 738.61 | 864.74 | 1024.14 | 1344.91 | 1449.54 | 1429.60 | 1315.56 | 1236.63 | 1150.39 | 891.44 | 737.45 |

m³ of water/year
12, 37.3 m³ of water
For a 300 m² greenhouse footprint: m³ of water/year/m² per square foot = 43.12

Forage crops play a major role in the economics of the operation of the solar desalination greenhouse 301. Further, though the solar desalination greenhouse 301 is suitable for water and labor intensive crops forage crops are more desirable, specifically salt tolerant barley. From a preliminary test conducted in a pilot apparatus barley was produced reaching harvest maturity in ten days. Considering 365 days in the year, there will be 36.5 crops in one year. Each crop weighs 24.65 metric tons, current barley forage sells for USD$280 per metric ton. Thus, the solar desalination greenhouse 301 based upon the assumptions in this disclosure has the potential of producing $250,000 annually, as is outlined in Table III.

TABLE III
Forage Production and Income Potential

| | | |
|---|---|---|
| Days per year | 365 | days |
| Duration for crop maturity | 6 | days |

| | |
|---|---|
| Crops per year | 60.00 |
| Ton per crop | 25.00 |
| Total tonnage per year | 1500.00 |
| Value per ton (USD) | $300.00 |
| Total value of annual crop production | $450,000.00 |

TABLE IV
Overall Economic Model
Basic Economic Feasibility

| Product | Product: Barley forage (green fodder) | |
|---|---|---|
| Market | Fodder as a feed for animals was 150 Million metric tons, 2011. | |
| Market | Target market is water scarce regions that pay the Highest prices such | |
| Price | as in the Gulf Cooperation Countries) $300-$500 USD per metric ton. | |
| Financing | Fixed Capital (United States Dollars) | |
| | Equipment- Conveyers, pumps irrigation system, Grinder, forklift, | 60,000 |
| | storage tanks, piping: | |
| | Land- One acre | 10,000 |
| | Buildings- 500 square meter greenhouse with 300 square meters for forage | 120,000 |
| | production including concrete slab, covers, conduits, cooling & ventilation | |
| | equipment, crates, pellets, irrigation system, SBCC | |
| | Power- Photovoltaics, batteries, converters and cables (5 KW) | 40,000 |
| | Pre-operating Expenses [symbol] (engineering, supervision) | 20,000 |
| | Total Fixed Capital | 250,000 |
| Working | Water- Brackish or sea water, 25,000 (@0.04 USD per cubic meter) | 1,000 |
| Capital | Labor- 8,000 hours @ 20 USD/HR | 160,000 |
| | Maintenance- 10% of non-land assets | 22,000 |
| | Depreciation- 10% of non land assets | 22,000 |
| | Seed, fertilizers etc. | 80,000 |
| | Marketing expenses & Other | 60,000 |
| | Total for Working Capital | 345,000 |
| Financing | ((250,000) + (115,000 [4 mo Work Cap])) + | |
| | 10% interest = 401,500 | |
| Sales | Forage 1500 metric tons/year @ 300 USD/metric ton | 450,000 |
| | Desalinated Water 10,000 cubic meters @ 0.50 USD/Cubic Meter | 5,000 |
| | Total Sales | 455,000 |
| Profit | Annual Profit: Sales-Annual Operating Expenses: 455,000 − | |
| | 345,000 = 110,000 USD | |
| Return | Annual Profit/Total financing = (110,000/((401,500)) × 100 = 27.4% | |

The conclusion from the above is that the Solar Desalination Greenhouse 301 could desalinate substantial quantities of water to meet the annual demand for 200 people profitably even if the water was sold at a very low price to make clean potable water accessible to people, especially poor people in developing countries. The fodder produced could support a small enterprise of raising dairy or goats to produce meet, milk and its by-products.

Evaporative cooling is such that when the temperature of outside ambient air is 45-50° C., current greenhouses can only reduce the temperature to about 36-38° C. which is not enough. A temperature of 25° C. is a more desirable target. In order to begin to bring the temperature down further below 36-38° C., the greenhouse 301 of the present invention provides for forced heating of outside air to lower its humidity before it is exposed to the evaporative cooler 309 and its evaporation pads or other structures. This is an important advance seen in the solar desalination greenhouse 301. The achievement of a lower temperature is also useful for better desalination as the temperature of the brine will be 22-25° C. while the saturated forced air as it exits the greenhouse may be close to 33° C. Typically, there may be a gradient of temperature for the air exiting the evaporative cooler 309 as it passes through the inside atmosphere 349 of the greenhouse 301 as it gets hotter but stays saturated with moisture from the crop in the crop modules 351. By producing a temperature reduction for air and brine, the greenhouse 301 is differentiated from the sea water greenhouse, from conventional greenhouses, and differentiated from any evaporative cooling arrangements that passively use non-preheated, higher humidity ambient outside air directly to result in a less efficient evaporative cooling process.

While the present invention has been described in terms of a desalination greenhouse 21, 301 and components which can be used with control to affect (1) fresh water production, (2) quick crop growing times, (3) combined year-round summer and winter operating configurations, the construction and process operation of a desalination greenhouse within the teaching above can be used to make a wide variety of alternate variations thereof.

Although the invention has been derived with reference to particular illustrative embodiments thereof, many changes and modifications of the invention may become apparent to those skilled in the art without departing from the spirit and scope of the invention. Therefore, included within the patent warranted herein are all such changes and modifications as may reasonably and properly be included within the scope of this contribution to the art.

What is claimed:

1. A desalination greenhouse comprising:
a greenhouse structure surrounding an inside atmosphere;
an evaporative cooler withing the greenhouse structure having a brackish water input and brackish water output, and a low humidity air input to allow the low humidity air to contact and be humidified by the brackish water input, and a high humidity cooled air out put into the atmosphere of the greenhouse structure;
a condensing heat exchanger having a humidified air input for receiving cooled humidified air from within the atmosphere within the greenhouse structure and an output for outputting moisture depleted air to the atmosphere outside the greenhouse structure, the condensing heat exchanger having a cooling fluid input and a cooling fluid output, and a fresh water condensate output.

2. The desalination greenhouse as recited in claim 1 wherein the low humidity air input has a lower relative humidity than ambient air surrounding an exterior of the greenhouse structure.

3. The desalination greenhouse as recited in claim 2 wherein the low humidity air input is obtained by heating ambient air before introduction into the low humidity air input of the evaporative cooler.

4. The desalination greenhouse as recited in claim 2 wherein the cooling fluid output of the condensing heat exchanger is also connected to the brackish water input of the evaporative cooler.

5. The desalination greenhouse as recited in claim 1 where the greenhouse structure includes materials that block near infrared radiation.

6. The desalination greenhouse as recited in claim 5 where a combination of the blocked near infrared radiation and the high humidity cooled air output into the atmosphere of the greenhouse structure combine to produce a cooler temperature than the exterior ambient temperature surrounding the desalination greenhouse.

7. The desalination greenhouse as recited in claim 1 wherein the low humidity air input is obtained by heating ambient air before introduction into the low humidity air input of the evaporative cooler.

8. The desalination greenhouse as recited in claim 1 and further comprising a plurality of live crop modules contained within the greenhouse structure.

9. The desalination greenhouse as recited in claim 8 wherein the live crop modules periodically produce a crop which, combined with a value of the fresh water condensate, enable the desalination greenhouse to operate profitably.

10. The desalination greenhouse as recited in claim 1 wherein the brackish water output has a higher salt concentration than the brackish water input and is suitably pure enough for a salt crystallization process by further evaporation.
